(19) United States
(12) Patent Application Publication
(10) Pub. No.: US 2020/0146319 A1
(43) Pub. Date: May 14, 2020

(54) FLOURLESS BAKED PRODUCTS AND METHODS OF PREPARATION

(71) Applicant: Foster Poultry Farms, Livingston, CA (US)

(72) Inventors: Danny Johns, Oakdale, CA (US); Paolo Ignacio Beltran, San Francisco, CA (US); Caroline Lafleur, San Francisco, CA (US)

(21) Appl. No.: 16/517,167

(22) Filed: Jul. 19, 2019

Related U.S. Application Data
(60) Provisional application No. 62/758,345, filed on Nov. 9, 2018.
(60) Provisional application No. 62/810,663, filed on Feb. 26, 2019.

(51) Int. Cl. A23L 13/50; A21D 13/41; A21D 13/04

(52) U.S. Cl. CPC A23L 13/52; A23V 2002/00; A21D 13/04; A21D 13/41

(57) ABSTRACT

The present invention relates to the fields of flourless baked products. The present invention relates to improved flourless baked products that have the appearance and texture of floured baked goods, and improved methods of making the products.

### RELATED CASES

This application claims priority to U.S. Provisional Application Ser. No. 62/758,345 filed on Nov. 9, 2018 and 62/810,663 filed on Feb. 26, 2019, which are incorporated herein by reference in their entirety to the full extent as permitted by law.

### TECHNICAL FIELD

The present invention relates to the field of edible baked products and methods of preparing the products, and more particularly to improving the appearance and taste of flourless baked products, and methods of preparation for the products wherein the baked products comprise at least about 40% protein.

### BACKGROUND

Due to health issues, more people are interested in flourless substitutes for traditional baked goods. Such issues may include an allergy to wheat or a desire to lower carbohydrate intake. However, flourless baked products lack gluten, which is the primary structural component of floured baked goods that creates texture. Currently available flourless baked goods that are high in protein and low in carbohydrates fail to have the appearance and texture of a traditional floured baked good. For example, many such products fail to have similar appearance, texture, or taste as its floured counterpart.

Further, generating flourless baked products at home can require a significant amount of time and effort, which is a significant impediment to home use. Accordingly, there is a need for premade flourless baked products that have the appearance, texture, and taste of traditional floured baked products.

### SUMMARY

The present disclosure provides an improved flourless baked product that has the appearance of a traditional flour-containing baked dough made with yeast. The disclosure provides a flourless baked product that has textural properties more closely approximating a flour-based product than other flourless baked products that currently exist. The flourless baked product may be high in protein and low in carbohydrates. Upon baking, it browns similar to a traditional flour based baked product. The flourless baked product may contain a distribution of air pockets/bubbles/voids inside the cooked product. In one embodiment, the flourless baked product is a cooked meat-based pizza crust that has similar texture and appearance to a flour-based pizza crust. The pizza crust may have a diameter of about 6 to 20 inches.

In one embodiment, the composition of the flourless baked product may include meat (poultry, beef, pork etc.) in an amount between about 40%-90% by weight of the composition. In other embodiments, the composition may include whole eggs, egg yolks, or egg whites in an amount between about 5%-20% by weight of the composition. The composition may include plant-based or milk-based protein isolate. The composition may include at least one type of cheese in an amount between about 2%-40% by weight of the composition. The composition may include at least one leavening agent in an amount between about 0.01%-4% by weight of the composition. The composition may further include water. Optionally, the water may be carbonated. The amount of water in the composition may be between about 2%-20% by weight. The composition may include at least one seasoning or flavoring, including but not limited to salt, extracts, and a flavored oil, in an amount of between about 0.1%-7% by weight of the composition.

The present disclosure also provides an improved method of producing a flourless baked product that has the appearance of a traditional flour-containing baked dough made with yeast. The method comprises one or more of the following steps: (a) a product forming step, (b) a flattening step, (c) a product setting step, (d) a cooking step, (e) a freezing step, and (f) a reheating step. In some embodiments, more than one of any of the previous steps may be included in the method, either alone or in combination. In another embodiment, two product forming steps may be included in the method to make the flourless baked product. As another embodiment, a product forming step and a product setting step may be included in the method to make the flourless baked product. In yet another embodiment, two product forming steps and a product flattening step may be included in the method to make the flourless baked product. Any number of combinations of the above steps may be used to create the flourless baked product, and more than one of each step type may be used in the method to make the flourless baked product. Further, in some embodiments the order of the steps is not critical to achieving the product with the desirable features.

In one embodiment, the product mixing procedure is as follows. Using a paddle style blender (e.g., Wolfking Blender), the steps comprise:

1. Add Chicken, Water, Potassium Carbonate, Salt, Dextrose, and Vinegar. Mix for about 7 minutes at about 24 rpm (no vacuum).

2. Add Cheese, Liquid Egg, and Natural Flavor. Mix for about 2 minutes at about 24 rpm (no vacuum).

3. Add Soy Isolate. Mix for about 2 minutes at about 24 rpm (no vacuum).

4. Inject carbon dioxide while mixing until the mixture reaches about 34-36 degrees F. The carbon dioxide may be added by direct injection. The amount of carbon dioxide added depends on the starting temperature of the meat batter to reach a final blend temperature before cooking of about 15° F. to about 40° F., or about 20° F. to about 35° F., or about 25° F. to about 30° F., or about 30° F. to about 40° F. In one embodiment, the carbon dioxide may be injected into the dough or meat batter at a temperature of about 25° to 28° F.

In other embodiments, the present disclosure describes a co-extrusion process to create a non-breaded hand-held product forms with a chicken exterior and various interior fillings. Such product forms may vary by type, shape and contents. In some cases, the forms are created with rounded edges, e.g., meatballs, sticks, croquettes, patties, tear drops, bars, fajitas, Stromboli, etc. These are filled with various interior fillings. The processes described herein result in a fully cooked product that is frozen for retail grocery store or restaurant settings.

In certain embodiments, the flourless food products described herein have less than about 30%, 25%, 20%, 15%, 10%, 5%, 2.5%, 2.0%, 1.5%, 1%, or 0.5% of the % Daily Value of total carbohydrates per serving of such food products. Further, they have between about 15% to about 50% of the % Daily Value of total fat per serving, and have between about 20 grams to 100 grams of protein per serving.

Additional embodiments of the present compositions and methods and the like will be apparent from the following description, drawings, examples, and claims. As can be appreciated from the foregoing and following description, each and every feature described herein, and each and every combination of two or more of such features, is included within the scope of the present disclosure provided that the features included in such a combination are not mutually inconsistent. In addition, any feature or combination of features may be specifically excluded from any embodiment or aspect. Additional aspects and embodiments are set forth in the following description and claims, particularly when considered in conjunction with the accompanying examples and drawings.

### REFERENCE TO COLOR FIGURES

This application file contains at least one drawing executed in color. Copies of this patent application publication with color drawings will be provided by the Office upon request and payment of the necessary fee.

### BRIEF DESCRIPTION OF THE DRAWINGS

The foregoing features of embodiments will be more readily understood by reference to the following detailed description, taken with reference to the accompanying drawings, in which:

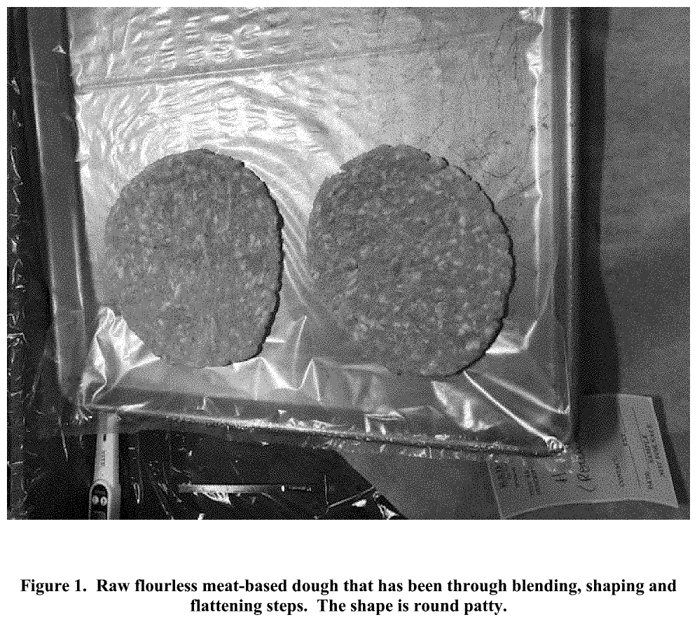

FIG. 1 is a photograph of a raw flourless meat-based dough that has been through blending, shaping and flattening steps. The shape is round patty.

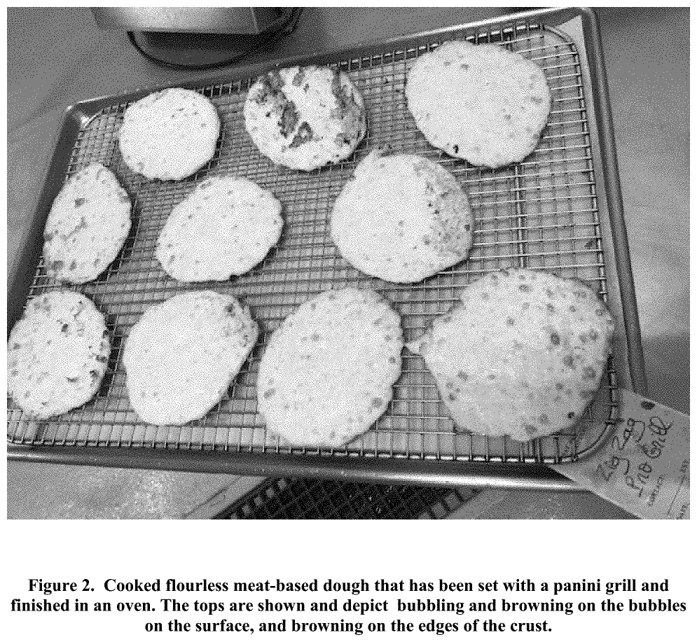

FIG. 2 is a photograph of a cooked flourless meat-based dough that has been set with a Panini grill and finished in an oven. The tops are shown and depict bubbling and browning on the bubbles on the surface, and browning on the edges of the crust.

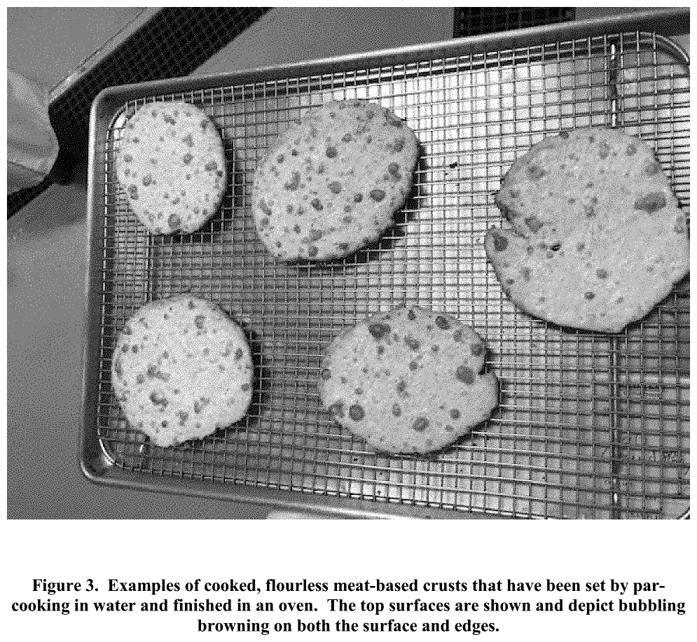

FIG. 3 is a series of photographs depicting examples of cooked, flourless meat-based crusts that have been set by par cooking in water and finished in an oven. The top surfaces are shown and depict bubbling and browning on both the surface and edges.

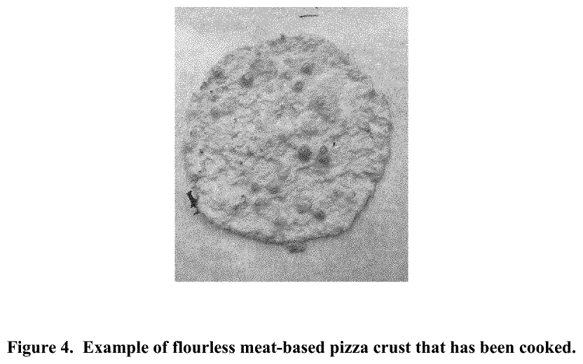

FIG. 4 is a photograph of a flourless meat-based pizza crust that has been cooked.

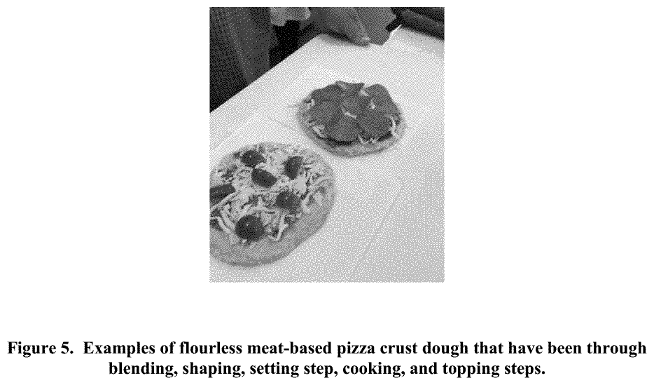

FIG. 5 shows examples of flourless meat-based pizza crust dough that have been through blending, shaping, setting step, cooking, and topping steps.

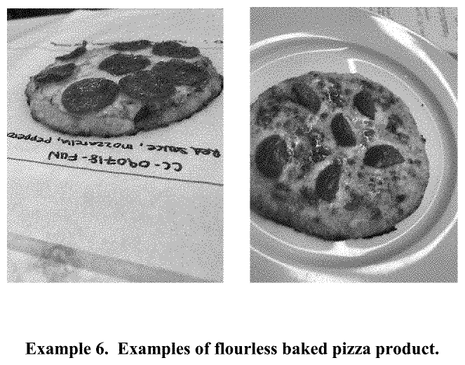

FIG. 6 shows examples of a flourless baked pizza product.

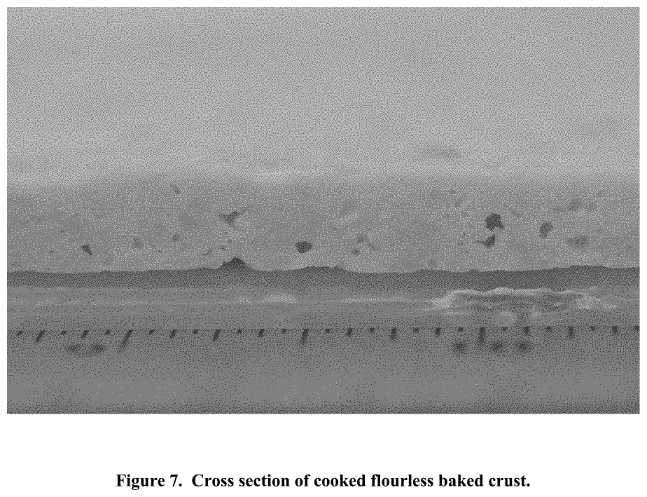

FIG. 7 shows a cross section of a cooked flourless baked crust.

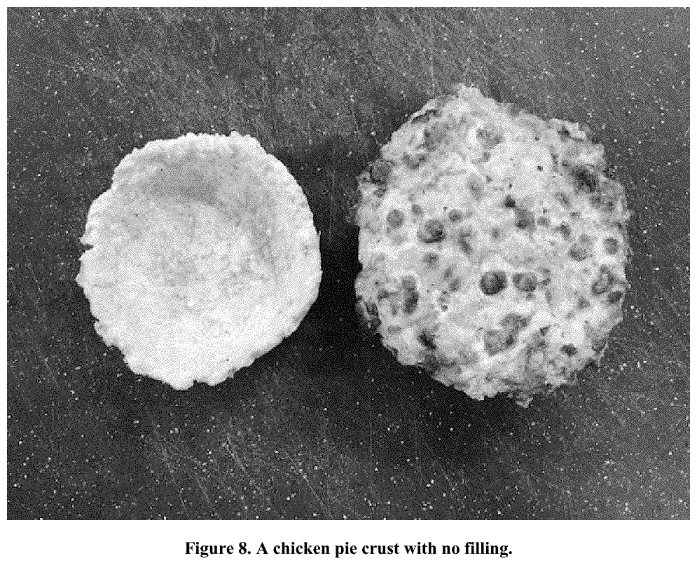

FIG. 8 shows a chicken piecrust with no filling.

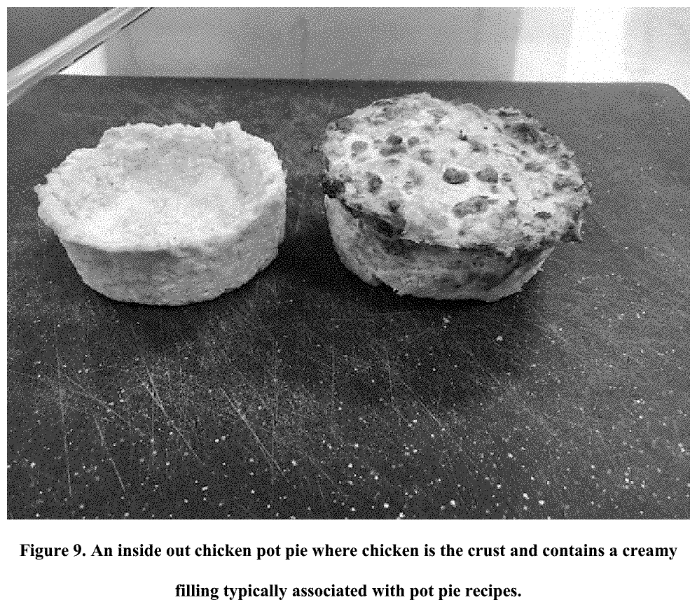

FIG. 9 shows an inside out chicken potpie where chicken is the crust and contains a creamy filling typically associated with potpie recipes.

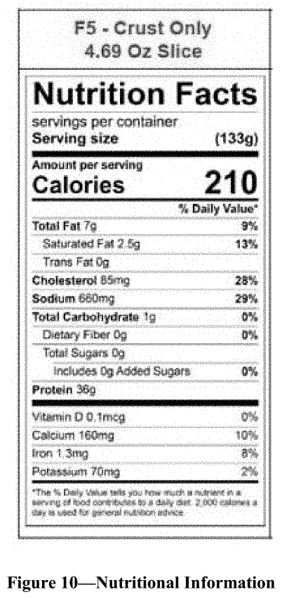

FIG. 10 is nutritional information of one embodiment of the present disclosure.

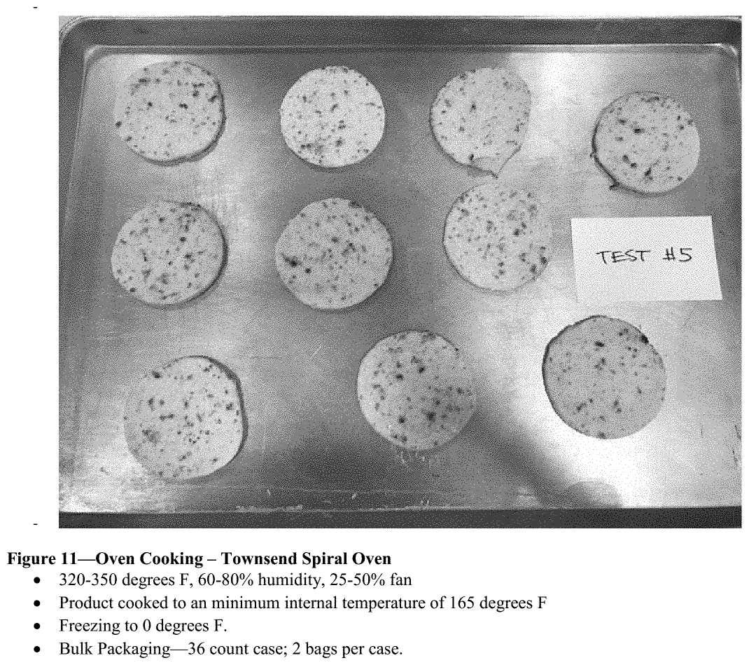

FIG. 11 is a photograph of patties of one embodiment of the present disclosure.

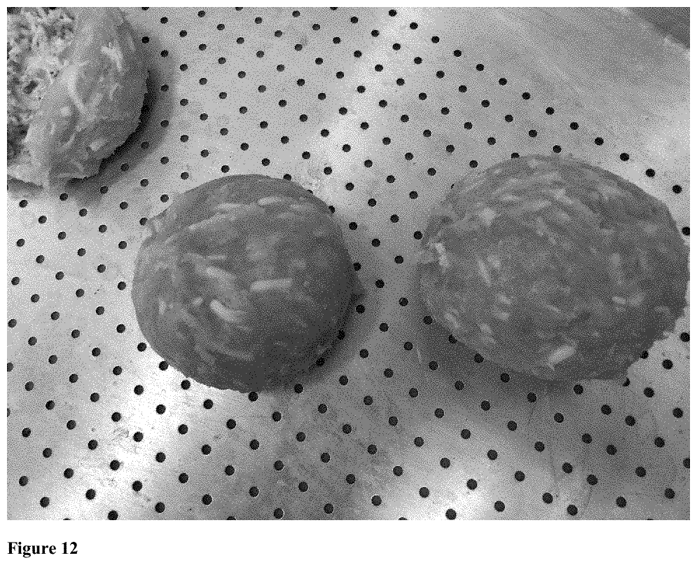

FIG. 12 is a photograph of meatball forms made according to one embodiment of the present disclosure.

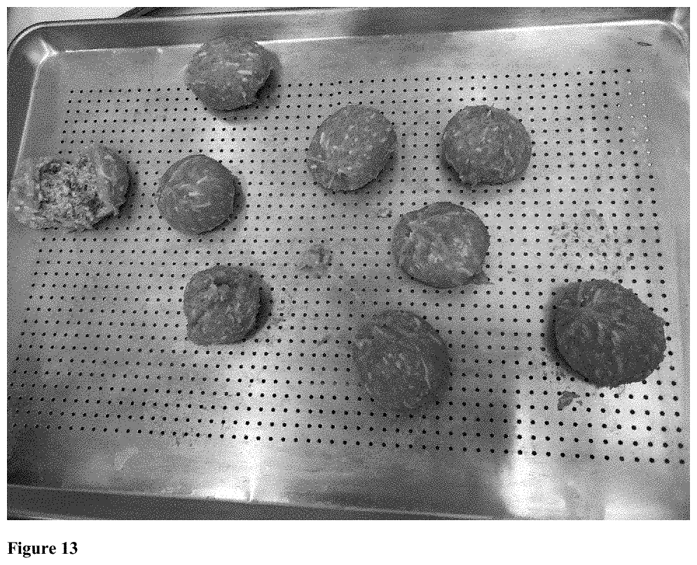

FIG. 13 is a photograph of meatball forms made according to one embodiment of the present disclosure.

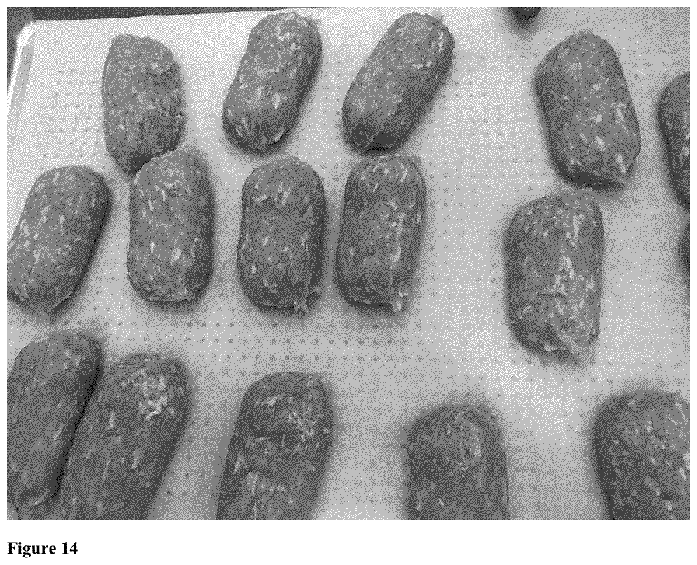

FIG. 14 is a photograph of bar/stick hand held forms made according to one embodiment of the present disclosure.

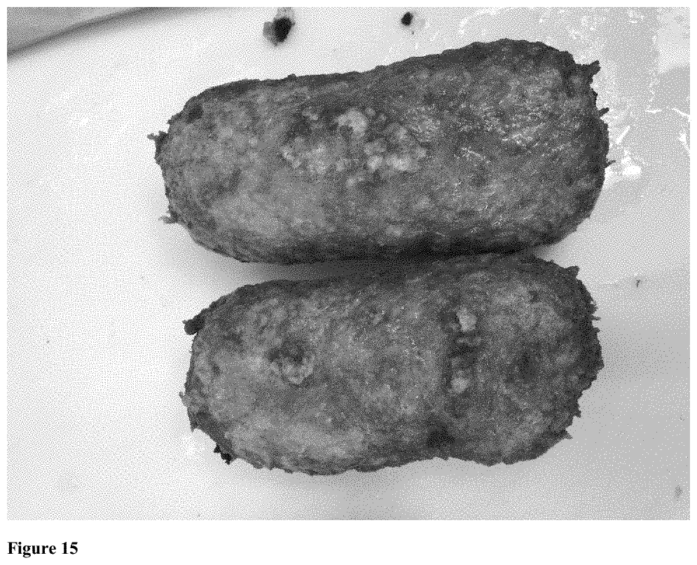

FIG. 15 is a photograph of cooked bar/stick hand held forms made according to one embodiment of the present disclosure.

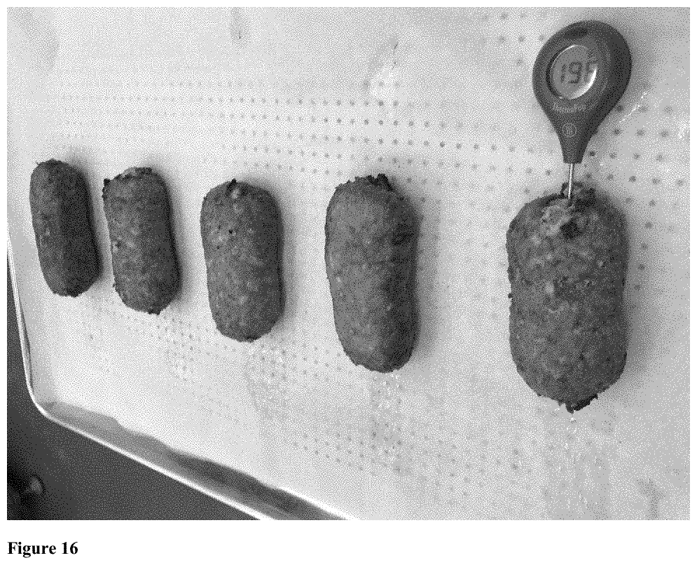

FIG. 16 is a photograph of cooked bar/stick hand held forms made according to one embodiment of the present disclosure.

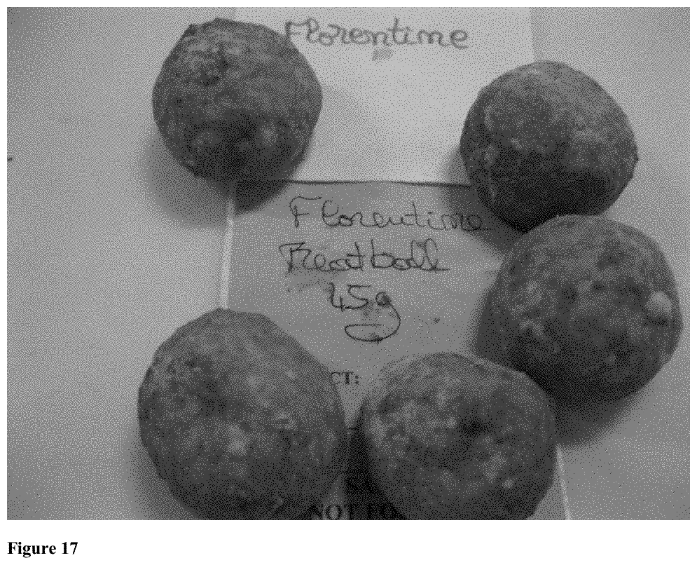

FIG. 17 is a photograph of Florentine meatball forms made according to one embodiment of the present disclosure.

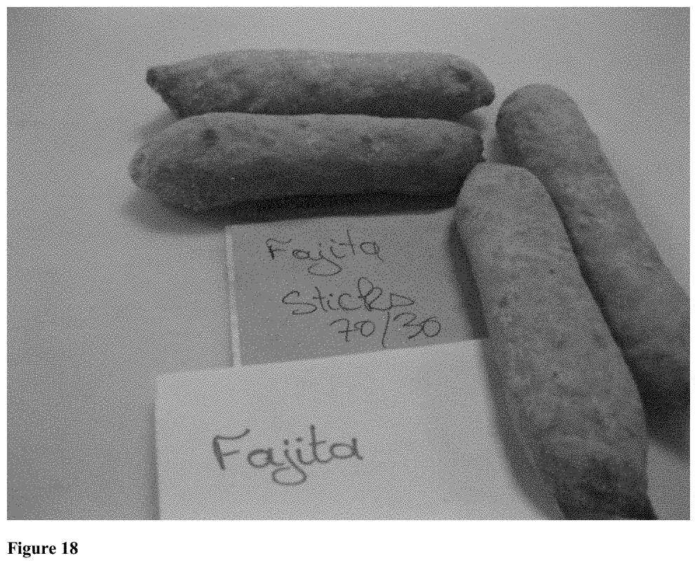

FIG. 18 is a photograph of fajita hand held forms made according to one embodiment of the present disclosure.

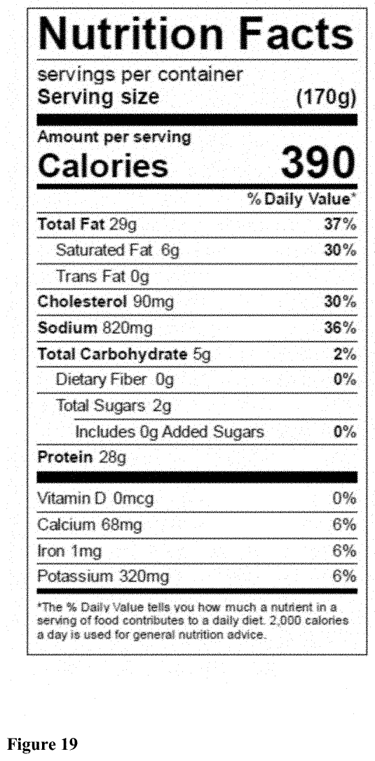

FIG. 19 is the nutritional statement for a bacon ranch meatball hand held made according to one embodiment of the present disclosure.

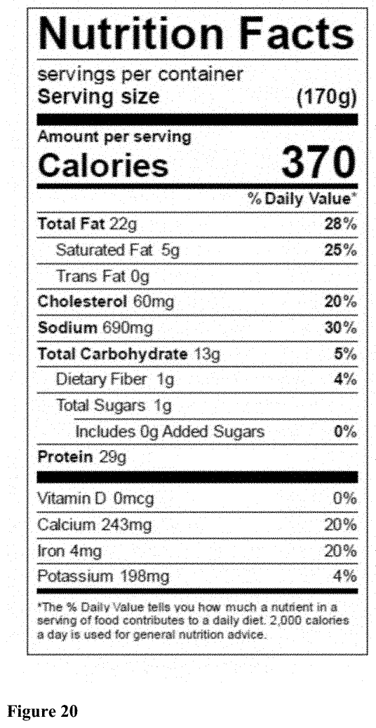

FIG. 20 is the nutritional statement for a Florentine meatball hand held made according to one embodiment of the present disclosure.

### DETAILED DESCRIPTION OF THE SPECIFIC EMBODIMENTS

The various aspects and embodiments will now be fully described herein. These aspects and embodiments may, however, be embodied in many different forms and should not be construed as limiting; rather, these embodiments are provided so the disclosure will be thorough and complete, and will fully convey the scope of the present subject matter to those skilled in the art. All publications, patents and patent applications cited herein, whether supra or infra, are hereby incorporated by reference in their entirety.

### I. DEFINITIONS

Unless defined otherwise, all terms and phrases used herein include the meanings that the terms and phrases have attained in the art, unless the contrary is clearly indicated or clearly apparent from the context in which the term or phrase is used. Although any methods and materials similar or equivalent to those described herein can be used in the practice or testing of the present invention, particular methods and materials are now described.

Unless otherwise stated, the uses of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges may be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors, which may be considered, include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. In addition, the disclosure of ranges is intended as a continuous range including every value between the minimum and maximum values plus the broadening of the range afforded by the use of the term “about” or “approximately.” Consequently, recitation of ranges of values herein are merely intended to serve as a shorthand method of referring individually to each separate value falling within the range, and each separate value is incorporated into the specification as if it were individually recited herein.

As used herein, “cheese” means dairy-based and non-dairy based cheeses.

As used herein, “low-moisture part-skim mozzarella” means a mozzarella cheese as defined in the FDA Code of Federal Regulations (“CFR”) Title 21, Volume 2 Part 133 Subpart B Section 133.158 (21CFR133.158). Specifically, the milkfat content is less than 45% by weight of the solids in the cheese but at least 30% by weight of the solids in the cheese. The moisture content is at least 45 percent but not more than 52 percent by weight as determined by the methods described in 21CFR133.5. Moisture, milkfat, and phosphatase levels in cheeses are determined by the following methods of analysis from “Official Methods of Analysis of the Association of Official Analytical Chemists,” 13th ed., 1980.

As used herein, “par-frying” means a cooking technique, sometimes also known as blanching or half-frying that involves partially frying the food but not browning it, so that it must be cooked again before serving.

As used herein, “protein” means material from a protein source such as chickens, turkeys, cattle, pigs, other animals, and plants (e.g., soybeans).

As used herein, “protein-rich” means a food product containing at least 40% protein.

### II. INTRODUCTION

As detailed below, the present invention provides an improved flourless baked product that has the organoleptic properties of flour-based baked product. The present invention further provides improved methods to manufacture flourless baked goods by incorporating one or more of the following steps: (a) a product forming step, (b) a flattening step, (c) a product setting step, (d) a cooking step, (e) a freezing step, and (f) a reheating step. The product forming step may comprise at least one of the following steps: (a) a blending step, (b) a carbon dioxide injection step, and (c) a shaping step. While the present disclosure provides examples for pizza crusts and other food items, it is not limited to such items and has general applicability to the manufacture of a host of other flourless baked goods, e.g., enchiladas, poppers, potpies (e.g., FIGS. 8-9), chips or crisps, wraps, hot pockets, tortillas, quesadillas, flautas, taquitos, bowls (e.g., similar to a bread bowl), etc.

### III. IMPROVED FLOURLESS BAKED PRODUCTS

In a general aspect of the inventive method of flourless baked goods, and as shown in FIGS. 1-3, the dough comprises a protein-rich substance that replaces flour. In one embodiment, the protein-rich substance is a meat. In a further embodiment, the meat is a type of poultry. In another embodiment, the poultry type is chicken or turkey. In yet another embodiment, the protein-rich substance includes both meat and eggs. Optionally, water, cheese, protein isolate, flavoring agents, stabilizers, additives, or preservatives may be added alone or in combination.

### A. Flourless Baked Product Composition

The present disclosure encompasses compositions for flourless baked products that include protein-rich substances. Various embodiments of the flourless composition include a meat component in an amount of about 10% to 90%, or 20% to 80%, or 30% to 70%, or 40% to 60% or 45% to 55% weight to weight of the composition. In certain embodiments, the meat source is a type of poultry. In further embodiments, either chicken, turkey, or a combination thereof is the type of poultry. In some embodiments, the meat is chicken breast. In other embodiments, the meat is turkey breast. In yet other embodiments, the meat component comprises a combination of chicken and turkey breast in a ratio of about 10 wt %/90 wt %, or 20 wt %/80 wt %, or 30 wt %/70 wt %, or 40 wt %/60 wt %, or 50 wt %/50 wt %, or 90 wt %/10 wt %, or 80 wt %/20 wt %, or 70 wt %/30 wt %, or 60 wt %/40 wt %. In some embodiments, the flourless baked products include additional protein-rich sources, such as eggs or cheese.

In some embodiments, the composition may include at least 50% by weight poultry, at least 3% by weight eggs, and at least 2% by weight cheese. In other embodiments, the composition comprises at least 50% by weight poultry and at least one of the following ingredients: (a) at least 3% by weight eggs, (b) at least 2% by weight cheese, (c) at least 0.05% by weight protein-binder, (d) at least 1% by weight water, (e) at least 0.05% by weight sodium phosphates, (f) at least 0.05% by weight salt, and (g) at least 0.01% by weight flavoring or spice.

In some embodiments, the composition may include at least 50% by weight poultry but less than 95% by weight poultry. In some embodiments, the composition may include at least 3% by weight binder but at least less than 25% by weight binder. In some embodiments, the composition may include at least 2% by weight cheese but less than about 40% by weight cheese.

In one embodiment the composition includes between about 60% by weight poultry and about 90% by weight poultry and at least one of the following: (a) between about 5% by weight and about 20% by weight egg whites, egg yolks, or whole eggs, (c) between about 2% by weight and about 6% by weight water, (d) between about 2% by weight and 35% by weight cheese, (e) between about 0.1% by weight and about 2% by weight binder, (f) between about 0.1% by weight and about 0.5% by weight sodium phosphates, (g) between about 0.1% by weight and about 2% by weight salt, (h) and between about 0.01% by weight and about 2% by weight flavoring or spice.

In another embodiment the composition includes between about 20% by weight and about 50% by weight cooked poultry and between about 20% by weight and about 50% by weight raw poultry, and at least one of the following: (a) between about 5% by weight and about 20% by weight water, (b) between about 0.1% by weight and about 2% by weight binder, (c) between about 1% by weight and about 30% by weight cheese, (d) between about 0.1% by weight and 0.5% by weight sodium phosphates, and (e) between about 0.1% by weight and 5% by weight seasoning. The seasoning may be one or more of salt, spices, and flavorings.

In some embodiments, the composition may include between about 0.01% by weight to about 5% by weight chemical leavening agent. Any edible chemical leavening agent may be used. Common chemical leavening agents known to those skilled in the art include ammonium carbonate, ammonium bicarbonate, baking powder, baking soda, cream of tartar (potassium bitartrate), dipotassium carbonate, monocalcium phosphate, potassium carbonate, potassium bicarbonate, sodium aluminum phosphate, and sodium aluminum sulfate.

In one embodiment, a poultry pizza crust may be made according to the following recipe:

| Ingredient | Formulation (wt %) |
|---|---|
| BL/SL chicken breast 3/16″ grind | 65-80 |
| Water | 1-3 |
| Liquid egg white | 5-15 |
| Low moisture part skim mozzarella cheese | 5-15 |
| Parmesan cheese, shredded | 1-3 |
| Soy protein isolate | 0.1-2 |
| Vinegar | 0.1-2 |
| Potassium carbonate | 0.1-2 |
| Salt | 0.1-2 |
| Natural flavor | 0.1-2 |
| Dextrose | 0.1-2 |
| Total | To 100% |

FIGS. 4-7 illustrate the pizza crusts described herein. As shown in FIG. 7, the crust may have voids of approximately 100 nanometers to 1 cm in size, which enhances the organoleptic qualities of the product. The pizza crust may have a diameter of about 6 to 20 inches.

### B. Method of Making Dough

Methods to make the flourless baked products are also contemplated by the present disclosure. Raw dough formation generally involves a blending step. One or more of the following steps may be employed in the method to make the flourless baked product: (a) a product forming step, (b) a flattening step, (c) a product setting step, (d) a cooking step, (e) a freezing step, and (f) a reheating step. In some embodiments, more than one of any of the previous steps may be included in the method, either alone or in combination. Generally, the order of steps is not critical. In one embodiment, two product forming steps may be included in the method. As another embodiment, a product forming step and a product setting step may be included in the method to make the flourless baked product. In yet another embodiment, two product forming steps and a product flattening step may be performed in the method. Any number of combinations of the above steps may be used to create the flourless baked product, and more than one of each step type may be employed.

### Product Forming Step

The method to make the flourless baked product may include at least one product forming step comprising a blending step. The blending step comprises combining or mixing two or more ingredients. An example of such ingredients includes ground meat and egg. Any mixing device may be used. Examples of mixing devices contemplated include household size mixers such as a Kitchen Aid countertop mixer, and commercial mixers such as a Blendtech Paddle Mixer or a FPEC 6000 lb Vacuum CO₂ Mixer. Ingredients may be added to the mixer either sequentially or in tandem. The ingredients may be mixed one or more times, and may be mixed all at once or at any stage between ingredient additions.

The product forming step may comprise a carbon dioxide injection step to increase the fluffiness of the product. Upon cooking, the carbon dioxide injection step increases the number and size of the voids in the cooked dough (i.e., pores, air pockets, bubbles). Such voids may be from about 100 nm to about 5 mm in size, and distributed about 100 nm to 1 cm apart.

One example of a carbon dioxide injector is a CO₂ Snow Horn. The carbon dioxide may be added by direct injection. The amount of carbon dioxide added depends on the starting temperature of the meat batter to reach a final blend temperature before cooking of about 15° F. to about 40° F., or about 20° F. to about 35° F., or about 25° F. to about 30° F., or about 30° F. to about 40° F. In one embodiment, the carbon dioxide may be injected into the dough or meat batter at a temperature of about 25° to 28° F.

The concentration and rate of carbon dioxide added to the dough may vary. Pure carbon dioxide may be added in the solid state by direct injection. As such, there will both be dissolved carbon dioxide and solid carbon dioxide in the meat batter during completion of the blending step. The incorporation of both the dissolved gas into the meat via sublimation and the residual solid phases of carbon dioxide in the meat may make it difficult to determine the exact levels of carbon dioxide according to Henry's Law. Many factors may affect the rate and incorporation of solid carbon dioxide into the meat to achieve a final meat batter temperature of about 25-28 degrees F. One goal is that the levels of carbon dioxide required to chill the meat down to the appropriate temperatures are adequate in creating the unique texture of meat more similar to the leavened texture of bread products. In contrast to the addition of solid carbon dioxide, the alternative application of carbon dioxide in the gas phase directly to meat batter may facilitate more accurate calculations of equilibrium rates of carbon dioxide dissolved in meat established through Henry's Law.

As mentioned, the addition of carbon dioxide in terms of amount, rate and volume is dependent on the starting temperature of the batter mix. For example, if ingoing ingredients are warmer, more carbon dioxide is needed to reach the target end temperature of 34-36 degrees F. If ingoing ingredients are colder, less is required. The carbon dioxide can be added by direct injection (e.g., piping directly into mixer) or by direct addition (e.g., manually added as other ingredients would be). In certain embodiments, the carbon dioxide may be added in the form of a solid “Snow.” It may be used to chill the meat down to a temperature more so than a calculated level of addition of carbon dioxide.

In one embodiment, the carbon dioxide is added during blending to prevent clumping. The meat batter will generally have a firm consistency that facilitates forming or extruding to shape. Meat that is too warm will be soft, can be deformed in shape and cause issues with downstream processes. A vacuum may optionally be used during the carbon dioxide injection step. However, part of the uniqueness of the crust or other food product is the residual carbon dioxide left in the meat batter. Thus, employing a vacuum can minimize the unique character created by removing a portion of the injected carbon dioxide.

The product forming step may comprise a shaping step. Shaping refers to converting meat batter into a shaped dough. In one aspect, shaping may be performed with the meat batter at a temperature between 25° to 28° F. In other embodiments, the meat batter temperature is between about 15° F. to about 40° F., or about 20° F. to about 35° F., or about 25° F. to about 30° F., or about 30° F. to about 40° F.

Shaping can be done a variety of ways. One embodiment involves shaping the meat batter into a round ball using a meatball former such as a Reiser Vmag Stuffer with Ball Control Attachment. Another embodiment involves shaping the meat batter into a meatball, puck, rounded puck, or other shape type of dough using a commercial shaper such as a Reiser Vmag Stuffer or Marel Revo-Portioner.

Shaped dough may be a variety of sizes, as measured by weight, such as about 2 to 30 ounces. Shaped dough may also be a variety of sizes, as measured by diameter after shaping, such as about 5 cm to about 20 cm. In some embodiments, the shaped dough uses between about 5-10 oz. of meat batter. In other embodiments, the shaped dough may be between about 1-16 inches in diameter, or up to about 25 inches in diameter. In yet other embodiments, the shaped dough may be between about 5-8 inches in diameter.

The shaping devices may use attachments to form the shaped dough. An example is an extrusion attachment, such as a BC236 6up extrusion attachment for a Reiser Vmag Stuffer. Another example is a guillotine extrusion attachment, such as a FM250 guillotine extrusion attachment for a Reiser Vmag Stuffer. Product forming may further include oiling to prevent sticking.

### Flattening Step

A flattening step can be achieved in a number of different ways. In one aspect, commercial belt presses are gentler during the flattening step and yield a more uniform round shape than rollers. Either countertop or commercial flattening devices may be used. An example of a countertop device is a Rondo Doge. In one embodiment, about 180 g of meat batter rolled with a Rondo Doge to size #7 will yield a dough diameter of approximately 6¾ inches.

Examples of commercial flattening devices include a Marel Platino Flattener, a ProGrill PG116004 TF, and a Tri-State 1200 Belt Press. Another example of a flattening device is a top and bottom belt system that rolls the meat dough flat using, for instance, a Reiser FM250 Gourmet Patty Former. The shaped meat dough may be any shape, such as a puck, a meatball, a patty, or a round patty. The meat dough may be unshaped meat batter. In some embodiments, the shaped meat dough is flattened to a thickness of between about 1/16 inch to about 1 inch. In another embodiment, the shaped meat dough is flattened to a thickness of between about ¼ inch to about ⅜ inch. The temperature of the dough during flattening may be between about 25° to 28° F. In other embodiments, the meat batter temperature is between about 15° F. to about 40° F., or about 20° F. to about 35° F., or about 25° F. to about 30° F., or about 30° F. to about 40° F.

In other aspects, oil may be applied to the meat dough, or other substances that decrease the stickiness of the dough may be used as part of the flattening step.

### Setting Step

The method of forming a flourless baked product may include a setting step. Setting refers to a pre-cook step that helps set or give structure to the meat batter or dough before it is cooked. A setting step may be employed to set the outside skin on the crust, patty or other product prior to entry into a continuous cooking oven. In some embodiments, without setting the skin, you may end up with sticking issues on the belts in the ovens. Both countertop and commercial setting devices and methods are contemplated. Examples of commercial setting methods include searing, grilling, or par frying.

An example of a countertop grilling device for setting is a Panini grill. An example of a commercial setting device is a ProGrill. Such grill may have a top grilling portion, a bottom grilling portion, or both a top and bottom grilling portion. When a bottom grilling portion is used, the temperature for setting the bottom of the dough can be between about 300-500 degrees F. The time for grilling the bottom of the dough can be between about 1-200 seconds. When a top grilling portion is used, the top grill or hot plate may be placed on the top of the dough, or the top grill or hot plate may be placed above the top of the dough, or a combination of placing the top of the grill or hot plate on the dough for at least part of the top grilling and placing the top of the grill or hot plate above the dough for at least part of the top grilling. The length of the setting step may vary and one purpose is to create toast marks. A combination of time and temperature is employed to achieve the desired level and intensity of toast marks or other visual cues.

Another example of a setting step is par frying. Oils or water can be used so set the skin. Here, water may be employed so that finished product characteristics are not oily to the touch based on contact with oil. Impingement cabinets or infrared cabinets may be utilized to achieve similar results. Likewise, for a small retail fryer or large pot filled with oil or water on the stove.

In one embodiment, the liquid for par frying is water. Par frying can occur at any temperature range that will set the dough. The dough may have a pale exterior color, with denatured protein on the surface helping to hold product intact. Raw meat will generally be toward the center. The product may still be flexible until fully cooked post par cooking. In one embodiment, the temperature for par frying may be between about 150-250 degrees F. In another the embodiment, the temperature for par frying may be between about 175-200 degrees F. The time for par frying the dough can be any time that will set the dough. In one embodiment, the raw dough is par fried for about 5-90 seconds to set the dough. For instance, the product may be completely submerged in either oil or water at a set temperature for a determined time to achieve 360-degree coverage and heat transfer into product. In another embodiment, the raw dough is par fried for about 15-60 seconds to set the dough.

### Cooking Step

The method of making the flourless baked product may include a cooking step. An example of a cooking device that can be used in the method is an oven. Either countertop or commercial versions of ovens may be used. Examples of commercial ovens include a MOS 1000 Oven, a GCO-106 TF Oven, and a Rational Oven. Any temperature that cooks the meat dough can be used. In one embodiment, the temperature for cooking is between about 200-500 degrees F. In another embodiment, the temperature for cooking is between about 350-400 degrees F. Optionally, the air in the oven may be moved during cooking employing ovens with built-in fans (e.g., convection ovens). Any percentage of the air in the oven may be moved during cooking. In one embodiment, between about 25%-100% of the air is moved during cooking. In another embodiment, between about 50%-100% of the air is moved during cooking. Optionally, steam may be added into the oven before, during, or after cooking. Ovens may be equipped with thermostats that regulate relative humidity. Direct steam injection controlled by the thermostat may regulate the amount of steam injected to control humidity. In one embodiment, the humidity in the oven is at ambient humidity. In another embodiment, the humidity in the oven is between about 20%-60% as measured standard humidity control systems. If the oven has a damper, the damper may be either open, closed, or partially open during cooking to control relative humidity.

Product that is being thermalized in an oven will give off moisture. This moisture will raise the humidity in the oven during cooking. Expelling all, some or none of this moisture through a damper system will assist in the control of humidity when considering the level of moisture release from product as well as the volume of product releasing moisture in a particular oven. In one embodiment, the dampers are open during cooking. In some embodiments, time for cooking may depend on the internal temperature of the meat dough. When the time for cooking depends on the internal temperature of the meat dough, the meat dough should be cooked until the internal temperature reaches at least about 130 degrees F., or about 140 degrees F., or about 150 degrees F., or about 165 degrees F. In other embodiments, the time for cooking may be between about 2-30 minutes depending on the temperature of the oven. In another embodiment, the cooking time may be between about 5-15 minutes.

### Freezing Step

The method may include a freezing step. Freezing may be accomplished by standard devices such as a continuous freezer cooled by either ammonia or carbon dioxide. The frozen dough may be stored frozen for up to one year or longer. If the frozen meat dough is raw or partially cooked meat dough, the method for making a flourless baked product may include a finishing step. The finishing step includes cooking the meat dough, and optionally includes a thawing step before cooking the meat dough. Thawing may occur at any temperature above freezing for any length of time until the meat dough is unfrozen. Cooking of the meat dough, either thawed or frozen may be performed as described in the cooking step above. The finishing step may optionally include adding an edible substance to the exterior of the top, bottom, or entire surface area of the meat dough to help prevent sticking of the dough during reheating. In one embodiment, the frozen or thawed meat dough is lightly coated with flour, corn meal, corn flour, or any other dusting edible substance known to those skilled in the art. In a further embodiment, only the bottom of the meat dough that will contact the cooking surface of the reheating device is coated. Other known ways to improve dough stickiness during reheating may also be used. For example, non-stick spray or using a non-stick surface may be employed.

### Reheating Step

Optionally, the reheating step may include a topping step to add additional ingredients on top of the meat dough. The additional ingredients may be anything edible. In one embodiment, the meat dough is a pizza crust, the additional ingredients are anything used for pizzas as known to those skilled in the art, and the additional ingredients are added on top of the crust.

Frozen meat dough that has been pre-cooked may be reheated. This may be done by any way known to a person skilled in the art. The reheating device may be a countertop or commercial version, such as pizza ovens, impingement ovens (with or without rolling belt), turbo chefs, microwaves, etc. The time for reheating depends on the reheating device being used.

Optionally, the reheating step may include an additional pre-reheating step. The pre-reheating step may comprise thawing of the frozen meat dough and adding an edible substance to the exterior of the top, bottom, or entire surface area of the meat dough to help prevent sticking of the dough during reheating. In one embodiment, the frozen or thawed meat dough is lightly coated with flour, corn meal, corn flour, or any other dusting edible substance known to those skilled in the art. In a further embodiment, only the bottom of the meat dough that will contact the cooking surface of the reheating device is coated. Other known ways to improve dough stickiness during reheating may also be used.

Optionally, the reheating step may include a topping step to add additional ingredients on top of the meat dough. The additional ingredients may be anything edible. In one embodiment, the meat dough is a pizza crust, the additional ingredients are anything used for pizzas as known to those skilled in the art, and the additional ingredients are added on top of the crust.

### C. Characteristics of the Flourless Baked Product

In one embodiment, the product is a crust having a thickness of about 0.5 cm to 5 cm, or about 1 cm to 4 cm, or about 1.5 cm to about 3 cm, or about 2 cm to 2.5 cm. The meat crust may have a water activity (Aw) after cooking that would fall in the category of perishable ready to eat products that would require refrigeration. In some embodiments, the Aw is at least about 0.5, or 0.6, or 0.7, or 0.8, or 0.9, or 1.0.

Further, the meat crust may have a moisture percentage after cooking of about 2% to about 20% by weight, or 5% to 15%, or 10% to 20% by weight.

The meat crust may have a fat percentage after cooking of less than about 40% by weight, or less than 35%, or less than 30%, or less than 25%, or less than 20%, or less than 15%, or less than 10% by weight.

The meat crust may have a protein content after cooking of about 30% to about 75% by weight, or about 35% to 60%, or about 40% to 50% by weight.

In another example, the meat crust may have a salt content of about 10% or less, and a pH of about 4.75 to about 6.5.

In certain embodiments, the pizza crusts described herein are subject to taste tests in a statistically significant population of adults who score the crusts as follows.

| Description | Characteristic | Response after tasting |
|---|---|---|
| Purchase intent | Top 2 box | >50% |
| Purchase intent | WPI* | 50 or higher |
| Overall liking | 9-point Hedonic mean^{§} | >6.0 |
| Value | Very or fairly good | >50% |
| | value | |
| Visual appearance | Like extremely or | >50% |
| | somewhat | |
| Overall liking- | 9-point Hedonic mean | >6.0 |
| Crust flavor | | |
| Chicken flavor | Just about right (JAR); | >50% responded as |
| | much too weak; or much | acceptable |
| | too strong | |
| Crust thickness | JAR; much too thick; | >50% responded |
| | or much too thin | as near ideal |
| Overall liking- | 9-point Hedonic mean | >6.0 |
| Crust texture | | |
| Meets expectations | Much to somewhat better | >50% |

*Weighted Purchase Intent (also known as WPI) is calculation of the mean of a purchase intent scale when the values for each response category of the scale (called weights) reflect the probability of purchase for that response category.
^{§}The most widely used scale for measuring food acceptability is the 9-point hedonic scale. David Peryam and colleagues developed the scale at the Quartermaster Food and Container Institute of the U.S. Armed Forces, for measuring the food preferences of soldiers. The scale was quickly adopted by the food industry.

### IV. EXAMPLES

The following examples are included to demonstrate certain embodiments of the present disclosure. Those of skill in the art should, however, in light of the present disclosure, appreciate that modifications can be made in the specific embodiments that are disclosed and still obtain a like or similar result without departing from the spirit and scope of the invention. Therefore all matter set forth is to be interpreted as illustrative and not in a limiting sense.

### Example 1—Pizza Crust

This example describes a composition for a pizza crust using chicken breast as a meat source. It further describes a method of making and baking the pizza crust, wherein the flourless baked product has the appearance and texture of a traditional flour-based pizza crust.

The flourless pizza crust dough uses skinless, whole chicken breast as a base. Other secondary ingredients include egg white, mozzarella cheese, parmesan cheese, water, and soy protein isolate. The egg white is liquid in form. The mozzarella cheese is low-moisture, part-skim, and firm to the touch. The parmesan cheese is grated to about 0.625″×0.625″×1″ pieces. The chicken flavor is a roast flavor. Other additives for the dough include sodium tripolyphophaste, sea salt, chicken flavor, and rosemary extract. The composition is as follows:

TABLE 1

| Ingredient | Batch (g) | Weight (g) | Percent |
|---|---|---|---|
| Chicken breast | 632.24 | 66.55 | 66.55% |
| Filtered water | 95.00 | 10.00 | 10.00% |
| Liquid egg white | 90.82 | 9.56 | 9.56% |
| Mozzarella cheese | 95.00 | 10.00 | 10.00% |
| Parmesan cheese | 19.00 | 2.00 | 2.00% |
| Soy protein isolate | 9.50 | 1.00 | 1.00% |
| Sodium triphosphate | 2.85 | 0.30 | 0.30% |
| Purified sea salt | 2.83 | 0.30 | 0.30% |
| Roast chicken flavor | 2.38 | 0.25 | 0.25% |
| Rosemary extract | 0.38 | 0.04 | 0.04% |

To make the pizza dough, chicken breast is cut into small pieces, between 1-1.5 inches. The cut chicken breast is then ground one time using a grinder with a 3/16 inch grind. 632.24 g of the ground chicken breast is weighed out. The mozzarella is shred to a thin shred size using a hand held kitchen cheese grater. The average mozzarella shred size is about 0.77 mm×2.25 mm×18 mm. 95.00 g of the shredded mozzarella is weighed out. 2.85 g of sodium tripolyphosphate is added to 95.00 g of filtered water and blended at high until dissolved shear using a Turbo Frother by The Brewologist. 2.83 g of the purified sea salt is added to the dissolved sodium tripolyphosphate mixture and blended until dissolved using a Turbo Frother by The Brewologist. The salt-dissolved mixture and weighed out ground chicken breast are added to a Kitchen Aid mixer and beat with paddle attachment at speed 2 for 2 minutes, until the mixture becomes tacky. In a bowl, 90.82 g of liquid egg white, 2.38 g of roast chicken flavor, and 0.38 g of rosemary extract are added together and mixed until blended. The egg white mixture and 9.50 g of soy protein isolate are added the chicken breast mixture, and mixed with the mixer on speed 2 using the paddle attachment for 2 minutes. The 95.00 g of thinly shred mozzarella cheese and 19.00 g of parmesan cheese are added into the mixer and the mixture is mixed at speed 2 using the paddle attachment for another 30 seconds. The final mixed product is the pizza crust dough.

180 g of the final pizza crust dough is weighed out and placed onto a lightly oiled parchment paper. Vegetable oil is used to lightly coat the surface. The dough is formed into an approximate circle by hand and then a second sheet of oiled parchment paper is placed on top of the dough. A Rondo Doge sheeter is used on top of the second parchment paper covering the dough, and sheeted using a thickness setting at #7 until diameter of dough is approximately 6¾ inches with a thickness between ¼ inch and ⅜ inch. This sheeted dough is the raw crust product. The dough is tacky and similar to a finely ground meat patty that has made very thin.

The raw crust product is then baked in a Blodgett Gas Convention Oven at 350 degrees F. for 10 minutes or until internal temperature reaches 165 degrees F. The cooked dough is the cooked pizza crust. The cooked crust is stiff and resembles a traditionally baked flour-based pizza crust.

The cooked pizza crust left to cool until reaches room temperature and then is hand-wrapped in First Street Plastic Crust. The wrapped pizza crust is then frozen to 0 degrees F.

The frozen pizza crust is reheated for additional use using a Lincoln low profile Impingement Pizza Oven using settings at 465R, 520L for 5 min. The reheated crust has a flat bottom and irregular top surface with toast points that resemble Baboli brand flour-based pizza crusts commonly found in grocery stores. The bottom of the reheated crust and the edges of the reheated crust brown similar to a traditional flour-based pizza crust.

### Example 2—Pizza Crust

This example describes a composition for a pizza crust using chicken breast as a meat-source, and it describes a method of making and baking the pizza crust, wherein the flourless baked product result has the appearance and texture of a traditional flour-based pizza crust.

The flourless pizza crust dough uses skinless, whole chicken breast as a base. Other secondary ingredients include egg white, mozzarella cheese, parmesan cheese, water, and whey protein isolate. The egg white is liquid in form. The mozzarella cheese is low-moisture, part-skim, and firm. The parmesan cheese is freshly grated to pieces of 0.625″×0.625″×1″. The chicken flavor is a roast flavor. Other additives for the dough include sodium tripolyphophaste, sea salt, chicken flavor, and rosemary extract. The composition is as follows:

TABLE 2

| Ingredient | Batch (g) | Weight (g) | Percent |
|---|---|---|---|
| Chicken breast | 119.79 | 66.55 | 66.55% |
| Filtered water | 18.00 | 10.00 | 10.00% |
| Liquid egg white | 17.21 | 9.56 | 9.56% |
| Mozzarella cheese | 18.00 | 10.00 | 10.00% |
| Parmesan cheese | 3.60 | 2.00 | 2.00% |
| Whey protein isolate | 1.80 | 1.00 | 1.00% |
| Sodium triphosphate | 0.54 | 0.30 | 0.30% |
| Purified sea salt | 0.54 | 0.30 | 0.30% |
| Roast chicken flavor | 0.45 | 0.25 | 0.25% |
| Rosemary extract | 0.07 | 0.04 | 0.04% |

To make the pizza dough, chicken breast is cut into small pieces, between 1-1.5 inches. The cut chicken breast is then ground one time using a grinder with a 3/16 inch grind. 119.79 g of the ground chicken breast is weighed out. The mozzarella is shred to a thin shred size using a hand-held kitchen cheese grater. The average mozzarella shred size is about 0.77 mm×2.25 mm×18 mm. 18.00 g of the shred mozzarella is weighed out. 0.54 g of sodium tripolyphosphate is added to 18.00 g of filtered water and blended at high shear until dissolved using a Turbo Frother by The Brewologist. 0.54 g of the purified sea salt is added to the dissolved sodium tripolyphosphate mixture and blended until dissolved using the Turbo Frother. The salt-dissolved mixture and weighed out ground chicken breast are added to a Kitchen Aid mixer and beat with paddle attachment at speed 2 for 2 minutes, until the mixture becomes tacky. In a bowl, 17.21 g of liquid egg white, 0.45 g of roast chicken flavor, and 0.07 g of rosemary extract are added together and mixed until blended. The egg white mixture and 1.80 g of soy protein isolate are added the chicken breast mixture, and mixed with the mixer at speed 2 for 2 minutes, using the paddle attachment. The 18.00 g of thinly shred mozzarella cheese and 3.60 g of parmesan cheese are added into the mixer and the mixture is mixed with the paddle attachment at mixer speed 2 for another 30 seconds. The final mixed product is the pizza crust dough. The dough is tacky and similar to a finely ground meat patty that has been pressed very thin.

180 g of the final pizza crust was sheeted, baked, wrapped, frozen, and then reheated as described in Example 1. The reheated crust has a flat bottom and irregular top surface with toast points. The bottom and edges brown as a flour-based pizza crust browns. The pizza crust may be made to have a diameter of about 6 to 20 inches.

### Example 3—Pizza Crust

This example describes a composition for a pizza crust using chicken breast as a meat-source, and it describes a method of making and baking the pizza crust, wherein the flourless baked product result has the appearance and texture of a traditional flour-based pizza crust.

The flourless pizza crust dough uses skinless, whole chicken breast as a base. Other secondary ingredients include egg white, mozzarella cheese, parmesan cheese, water, and soy protein isolate. The egg white is liquid in form. The mozzarella cheese is low-moisture, part-skim. The parmesan cheese is freshly grated. The chicken flavor is a roast flavor. Other additives for the dough include sodium tripolyphophaste, sea salt, chicken flavor, and rosemary extract. The composition is as follows:

TABLE 3

| Ingredient | Batch (g) | Weight (g) | Percent |
|---|---|---|---|
| Chicken breast | 119.80 | 66.55 | 65.46% |
| Filtered water | 18.00 | 10.00 | 9.84% |
| Liquid egg white | 17.21 | 9.56 | 9.40% |
| Mozzarella cheese | 18.00 | 10.00 | 9.84% |
| Parmesan cheese | 3.60 | 2.00 | 1.97% |
| Soy protein isolate | 1.80 | 1.00 | 0.98% |
| Sodium triphosphate | 0.54 | 0.30 | 0.30% |
| Purified sea salt | 0.54 | 0.30 | 0.29% |
| Roast chicken flavor | 0.45 | 0.25 | 0.25% |
| Rosemary extract | 0.07 | 0.04 | 0.04% |
| White corn flour | 2.99 | 1.66 | 1.63% |

To make the pizza dough, chicken breast is cut into small pieces, between 1-1.5 inches. The cut chicken breast is then ground once using a grinder with a 3/16 inch grind. 66.55 g of the ground chicken breast is weighed out. The mozzarella is shred to a regular shred size using a hand-held kitchen cheese grater. The average mozzarella shred size is about 2.0 mm×4.8 mm×45.0 mm. 10.00 g of the shredded mozzarella is weighed out. 0.54 g of sodium tripolyphosphate is added to 18.00 g of filtered water and blended at high shear until dissolved using a Turbo Frother by The Brewologist. 0.54 g of the purified sea salt is added to the dissolved sodium tripolyphosphate mixture and blended until dissolved using the Turbo Frother. The salt-dissolved mixture and weighed out ground chicken breast are added to a Kitchen Aid mixer and beat with paddle attachment at speed 2 for 2 minutes until the mixture becomes tacky. In a bowl, 17.21 g of liquid egg white, 0.45 g of roast chicken flavor, and 0.07 g of rosemary extract are added together and mixed until blended. The egg white mixture and 1.80 g of soy protein isolate are added the chicken breast mixture, and mixed with the mixer using the paddle attachment for 2 minutes at mixer speed 2. The 18.00 g of thinly shred mozzarella cheese and 3.60 g of parmesan cheese are added into the mixer and the mixture is mixed for another 30 seconds at mixer speed 2. The final mixed product is the pizza crust dough.

180 g of the final pizza crust dough is weighed out and placed onto a lightly oiled parchment paper using vegetable oil. The dough is formed into a circle by hand and then a second sheet of oiled parchment paper is placed on top of the dough. A Rondo Doge sheeter is used on top of the second parchment paper covering the dough, and sheeted with setting #7 until diameter of dough is approximately 6¾ inches and the thickness is between ¼ inch and ⅜ inch. This sheeted dough is the raw crust product. The dough is tacky and similar to a finely ground meat patty.

The raw crust product is then baked in a Blodgett Gas Convection Oven at 350 degrees F. for 10 minutes or until internal temperature reaches 165 degrees F. The cooked dough is the cooked pizza crust.

The cooked pizza crust is allowed to cool to room temperature and then hand-wrapped with First Street Plastic Wrap. The wrapped pizza crust is then frozen to 0 degrees F. until it needed.

The frozen pizza crust is removed from the freezer and unwrapped. The bottom of the frozen pizza crust is sprinkled with 2.99 g of white corn flour. The corn floured frozen pizza crust is placed on a baking pan and topped with pizza toppings. The frozen pizza crust is reheated for additional use using a Lincoln low profile impinger using settings at 465R, 520L for 5 min. The reheated crust has a flat bottom and an irregular top surface with toast points. The bottom and edges brown similar to a flour-based pizza crust.

### Example 4—Method of Making Meat Batter

An example of a method of making a meat batter for a flourless baked product is provided. The forming method of making a meat batter involves a blending step. As a first step, chicken breast that has been ground using a 3/16 inch grinder is conveyed into FPEC 6000 lb Vacuum CO₂ Mixer. In a second step, brine comprising water, dry ingredients, and rosemary extract is added to the mixer. In a third step, cheese is conveyed to the mixer via an auger feeder. In a fourth step, liquid egg and chicken flavoring are vacuum fed to the mixer. As a fifth step, the mixer is run at 6-30 rpm for between about 5 minutes and about 15 minutes without any vacuum to form a meat batter. The batter has a uniform distribution of cheese and is tacky to the touch. As a sixth step, carbon dioxide is added to the meat batter to a temperature between 25-28 degrees F. Carbon dioxide addition is the last step of blending, and it is added by direct injection into the meat batter. Vinegar is optional as antimicrobial in brine solution.

### Example 5—Method of Making Meat Batter

An example of a method of making a meat batter for a flourless baked product is provided. The forming method of making a meat batter involves a blending step. As a first step, chicken breast that has been ground using a 3/16 inch grinder is conveyed into FPEC 6000 lb Vacuum CO₂ Mixer. In a second step, brine comprising water, dry ingredients, and rosemary extract is added to the mixer. In a third step, the mixer is run at about 6-30 rpm for between about 3 minutes and about 10 minutes without any vacuum to form a meat batter. The batter has a uniform distribution of cheese and is tacky to the touch. As a fourth step, cheese and pre-cooked ¼-inch chicken pieces are conveyed to the mixer. In a fifth step, liquid egg and chicken flavoring are vacuum fed to the mixer. In a sixth step, the mixer is run at about 6-30 rpm for an additional 3-10 minutes. In a seventh step, carbon dioxide is added to the meat batter to a temperature between 25-28 degrees F. Carbon dioxide addition is the last step of blending and is added by direct injection into the meat batter.

### Example 6—Method for Shaping Meat Dough

An example of shaping meat batter into a meat dough is provided. About 5-10 oz. of meat batter at a temperature of about 25-28 degrees F. is formed into a round meatball shape using a Reiser Vmag Stuffer with a BC236 6up extrusion attachment. The resultant meatballs are a round-type shape typically having a diameter of about 40-80 mm.

### Example 7—Method for Shaping Meat Dough

Another example of shaping meat batter into a meat dough is provided. 5-8 oz. of meat batter at a temperature of about 25-28 degrees F. is formed into a puck shape using a Reiser Vmag Stuffer with a FM250 guillotine extrusion attachment. The resultant puck typically has a diameter of about 5 inches. The diameter is set at 5″. Depending on the size of the crust, the thickness could range from 1-5″.

### Example 8—Methods of Shaping Meat Dough

An example of a method to shape meat batter into a shaped meat dough is provided. About 3-16 oz of meat batter at a temperature of about 25-28 degrees F. is formed into a round patty shape using a Marel Revo-Portioner. The resultant round patty has a diameter of about 5-8 inches and a thickness of about ¼″ to ⅜″.

### Example 9—Method of Flattening Meat Dough

An example of a method for flattening meat dough is provided. Round meatball-type shaped meat doughs, pucks or patty shapes are flattened through a Marel Platino Flattener at a thickness setting between ¼″ to ½″ to a thickness of between about ¼ inch to about ⅜ inch. The temperature was set at about 25-28 degrees F.

### Example 10—Method of Flattening Meat Dough

An example of a method for flattening meat dough is provided. Meat patty pucks are flattened to between about ¼ inch to about ⅜ inch by a top and bottom belt included as part of the Reiser FM250 extrusion attachment to a thickness of about ¼″ to ⅜″. The temperature was set at about 25-28 degrees F.

### Example 11—Method of Flattening Meat Dough

An example of a method for flattening meat dough is provided. Meat batter shaped into meatballs, patties, or pucks are flattened to between about ¼ inch to about ⅜ inch by the top and bottom belts on the ProGrill PG116004 TF. The temperature was set to 485 degree F. and thickness set to ¼″ to ⅜″.

### Example 12—Method of Setting Meat Dough

A method for a setting shaped meat dough is provided. A Panini grill that has a top and bottom grilling plate is set to between about 350-450 degrees F. Shaped meat dough is placed on the bottom grill of the panini grill for between about 15-60 seconds and the top grill is placed ⅛″ to ½″ above the dough during the grilling of the bottom of the shaped meat dough. This forms bottom and top skins on the shaped meat dough. This resulted in irregular, non-patternable bubbles appearing in the cross-section of the crust.

### Example 13—Method of Producing Meat Crust Product

The following poultry crust was prepared:

| | Formulation | Formulation |
|---|---|---|
| Ingredient | (wt %) | Range (wt %) |
| BL/SL chicken breast 3/16″ grind | 73.45 | 65-80 |
| Water | 2 | 1-3 |
| Liquid egg white | 9.56 | 5-15 |
| Low moisture part skim | 10 | 5-15 |
| mozzarella cheese | | |
| Parmesan cheese, shredded | 2 | 1-3 |
| Soy protein isolate | 1 | 0.1-2 |
| Vinegar | 1 | 0.1-2 |
| Potassium carbonate | 0.15 | 0.1-2 |
| Salt | 0.3 | 0.1-2 |
| Natural flavor | 0.29 | 0.1-2 |
| Dextrose | 0.25 | 0.1-2 |
| Total | 100% | To 100% |

The product mixing procedure is as follows. Using a paddle style blender (e.g., Wolfking Blender), the steps comprise:

1. Add Chicken, Water, Potassium Carbonate, Salt, Dextrose, and Vinegar. Mix for 7 minutes at 24 rpm. No vacuum.

2. Add Cheese, Liquid Egg, and Natural Flavor. Mix for 2 minutes at 24 rpm. No vacuum is used.

3. Add Soy Isolate. Mix for 2 minutes at 24 rpm. No Vacuum.

4. Inject carbon dioxide while mixing until mixture reaches 34-36 degrees F.

The product is then stuffed in plastic casings to a round diameter of 8.5 inches. This can be performed with an Amfec Vacuum Stuffer and Tipper Tie clipping system. The product length is approximately 30 inches and weighs about 55 lbs. Logs of the dough are then placed on custom racks with rounded bottoms to prevent flat spots during freezing.

The dough is then subjected to blast freezing by placing it in a blast freezer for 24-48 hours until an internal temperature of 0 degrees F. is reached. Freezer temperatures are set between −35 and −25 degrees F. with fans on to facilitate air movement.

A tempering step is next performed by placing the product in a tempering room until it reaches a uniform temperature between 24-28 degrees F.

The product is then sliced by removing the plastic casing from the product. The tempered logs are placed into, e.g., a Weber Textor 700 Slicer, and sliced to ¼-inch thickness. Product exiting the slicer is shuttled to a ProGrill Belt and evenly spaced to maximize belt usage.

Before oven cooking, the bottom of the sliced product is set and seared to develop color under ProGrill settings, e.g., 485 degrees F. belt temperature, 120-second belt speed.

Alternatively, instead of utilizing the ProGrill to sear and create color, the product can be sliced and sent directly into the oven under similar cooking settings. Immediately after the oven, an Infrared Browning unit (Heat and Control, Inc.) can add color directly to the top surface of the sliced patties. The product can then be shuttled to the freezer.

The product as shown in FIG. 11 may thereafter cooked in an oven (e.g., Townsend Spiral Oven) at about 320 degrees F., about 60% to 80% humidity and about 25% to 50% fan to an internal temperature of about 165 degrees F. Thereafter, the product may be consumed or frozen for storage at a temperature of about 0 degrees. The product's nutritional information is shown in FIG. 10.

### Example 14—Taste Test of Meat Crust Product

The pizza crusts described in the foregoing examples were subjected to a taste test by 34 adults. They scored the crust as follows:

| | | Response after |
|---|---|---|
| Description | Characteristic | tasting |
| Purchase intent | Top 2 box | 70% |
| Purchase intent | WPI | 86 |
| Overall liking | 9-point Hedonic mean | 7.44 |
| Value | Very or fairly good value | 67% |
| Visual appearance | Like extremely or somewhat | 97% |
| Overall liking- | 9-point Hedonic mean | 7.41 |
| Crust flavor | | |
| Chicken flavor | JAR; much too weak; or | 71% responded |
| | much too strong | as acceptable |
| Crust thickness | JAR; much too thick; or | 79% responded |
| | much too thin | as near ideal |
| Overall liking- | 9-point hedonic mean | 6.82 |
| Crust texture | | |
| Meets expectations | Much to somewhat better | 67% |

### Example 15—Co-Extruded Process to Create a Non-Breaded Hand-Held Product Form with a Chicken Exterior and Various Interior Fillings

In this Example, various product forms are created with rounded edges, e.g., meatballs, sticks, croquettes, patties, tear drops, bars, Stromboli, etc. These are filled with various interior fillings. The process below describes a fully cooked product that is frozen for retail grocery store or restaurant settings. Generally, machines (as identified below) are used to co-extrude the exterior and interior fillings.

The exterior of the food product is made with the following chicken-based exterior formula:

| Ingredient | Content (wt %) |
|---|---|
| BL/SL Chicken Breast 5/32″ Grind | 80-90% |
| Water | 1-5% |
| Liquid Egg White | 5-10% |
| Low Moisture Part Skim Mozzarella Shredded | 5-10% |
| Parmesan Cheese Shredded | 1-5% |
| Isolated Soy Protein | 0.1-2% |
| Salt | 0.1-2% |
| Natural Flavor | 0.1-2% |
| Dextrose | 0.1-2% |

The product interior varies according to the type and flavoring desired. For example, the interior may be vegetables (e.g., vegetarian), cheese, meat (e.g., bacon or other meat) or any other suitable filling.

The exterior meat processing method comprises grinding and blending steps as follows:

1. Grinding in a two-part grinding process:
a. First grind chicken breast to about ½ inch size; and
b. In the second step, the chicken breast is ground to about 5/32 inch size.

2. Using a Blendtech Paddle Mixer or a FPEC Vacuum CO₂ Mixer with paddle, ingredients are blended as follows:
a. Add ground chicken to blender;
b. Add salt, dextrose, water, natural flavor to blender;
c. Mix 5 minutes with 15+ inHG mercury on vacuum;
d. Add egg whites, mozzarella, and parmesan to blender;
e. Mix 3 minutes with 15+ inHG mercury on vacuum;
f. Add soy isolate to blender;
g. Mix 4 minutes with 15+ inHG mercury on vacuum;
h. Inject carbon dioxide (CO₂) to chill the product to about 30-32 degrees F.

After blending, the product is formed as follows:

### 1. Forming Alternative 1

a. Formed into round, oblong or bar shaped products (e.g., meatballs, sticks, croquettes, patties, tear drops, bars, Stromboli, etc.). The raw weight was about 4-6.5 oz.

b. The forming is performed using a Reiser Vmag Unit HP30E at the following settings:
i. Double Screw—36 8% compression/48Cx367
ii. Stopper—Spiral
iii. Ring Gear—Standard
iv. Scraper—Standard
v. Housing—Cast 100 mm
vi. Hopper—350 L/110 L with loader

c. Co-extrusion attachments included:
i. Machine Type—RC100/V500
ii. Gauging Block—15 mm tapered
iii. Grinder—4 mm final
iv. Nozzle—43 mm/22 mm

### 2. Forming Alternative 2

a. Formed into round, oblong or bar shaped products (e.g., meatballs, sticks, croquettes, patties, tear drops, bars, Stromboli, etc.). The raw weight was about 4-6.5 oz.

b. The forming is performed using a Rheon model-KN551 encrusting machine. The forming equipment may be many shapes and sizes. Changes in shutter and nozzle type are required to change various drop shapes and weights.

The products are formed by taking the raw chicken mix and extruding it around the filling at various ratios from about 40:60 to about 60:40 exterior:interior. The meat block should be kept below 32 degrees F. during forming. In some cases, the product shape resembles a rectangle with rounded edges.

The products are then subjected to par frying to set the product skin or surface. This may be performed by immediately partially frying in vegetable oil for 35 seconds at about 365 degrees F. A Stein M Fryer or similar fryer may be utilized. The product is then cooked in the oven using a Stein Twin Drum Oven or similar oven and cooked to a minimum internal temperature of 165 degrees F. The product is then frozen using a Frigoscandia GyroCompact Spiral Freezer or similar freezer so that its internal temperature is lowered to 0-10 degrees F. before packaging.

FIGS. 12 to 18 are product forms made according to this Example. FIG. 19 is nutritional statement for a bacon ranch hand held meatball product made according to this Example. FIG. 20 is a nutritional statement for a Florentine hand held meatball product according to this Example.

The embodiments of the invention described above are intended to be merely exemplary; numerous variations and modifications will be apparent to those skilled in the art. All such variations and modifications are intended to be within the scope of the present invention as defined in any appended claims.

1. A flourless composition, comprising at least 50% by weight poultry, at least 3% by weight eggs, and at least 2% by weight cheese.

2. The composition according to claim 1 further comprising at least 0.05% by weight protein-binder; at least 1% by weight water; at least 0.05% by weight sodium phosphates; at least 0.05% by weight salt; and at least 0.01% by weight flavoring or spice.

3. The composition according to claim 1 wherein it is in the form of a product selected from the group consisting of pizza crust, meatballs, sticks, croquettes, patties, tear drops, bars, fajitas, and Stromboli.

4. The composition according to claim 3 wherein the product is a pizza crust having a thickness selected from the group consisting of about 0.5 cm to 5 cm, about 1 cm to 4 cm, about 1.5 cm to about 3 cm, and about 2 cm to 2.5 cm.

5. The composition according to claim 3 wherein the product is a pizza crust having a water activity (Aw) after cooking of at least about 0.5.

6. The composition according to claim 3 wherein the product has a moisture percentage after cooking of about 2% to about 20% by weight.

7. The composition according to claim 3 wherein the product has a fat percentage after cooking of less than about 40% by weight.

8. The composition according to claim 3 wherein the product has a protein content after cooking of about 30% to about 75% by weight.

9. The composition according to claim 2 wherein the product is a pizza crust having a plurality of voids of about 100 nanometers to 1 cm in size.

10. The composition according to claim 2 wherein the product is a pizza crust having a diameter of about 6 to 20 inches.

11. The composition according to claim 2 wherein the product is a pizza crust that when cooked and subjected to a taste test in a statistically significant population of adults, greater than 50% of the adults respond that the crust thickness is near ideal.

12. A method of producing a flourless baked product that has the appearance and taste of a traditional flour-containing baked dough, comprising: (a) a product forming step, (b) a flattening step, (c) a product setting step, (d) a cooking step, (e) a freezing step, and (f) a reheating step.

13. The method according to claim 12 wherein the product forming step comprises the use of carbon dioxide.

14. The method according to claim 12, comprising injecting carbon dioxide while mixing until the mixture reaches about 34 to 36 degrees F.

15. A flourless pizza crust, comprising:
a. about 50% to 85% by weight chicken;
b. about 1% to 10% by weight water;
c. about 1% to 15% by weight egg white; and
d. about 0.1% to 5% by weight flavoring.

16. The pizza crust according to claim 15 further comprising cheese.

17. The pizza crust according to claim 16 wherein the cheese comprises mozzarella cheese in an amount of about 2% to 20% by weight.

18. The pizza crust according to claim 16 wherein the cheese comprises parmesan cheese in an amount of about 0.1% to 10% by weight.

19. The pizza crust according to claim 15 wherein the chicken is about 60% to 70% by weight, the water is about 5% to 15% by weight, and the egg white is liquid egg white in an amount of about 5% to 15% by weight.

20. The pizza crust according to claim 15 further comprising soy protein isolate in an amount of about 0.1% to 5% by weight.

21. The pizza crust according to claim 15 further comprising sodium triphosphate in an amount of about 0.1% to 5% by weight.

22. The pizza crust according to claim 15 further comprising rosemary extract in an amount of about 0.01% to 1% by weight.

23. The pizza crust according to claim 15 that when cooked and subjected to a taste test in a statistically significant population of adults, the overall liking of the pizza scores greater than 6.0 on a 9-point Hedonic mean.

24. A flourless food product, comprising:
a. about 65% to 90% chicken;
b. about 1% to 5% water;
c. about 5% to 10% liquid egg white;
d. about 5% to 10% mozzarella cheese;
e. about 1% to 5% parmesan cheese;
f. about 0.1% to 2% isolated soy protein;
g. about 0.1% to 2% salt;
h. about 0.1% to 2% natural flavoring; and
i. about 0.1% to 2% dextrose;
wherein the percentages are by weight of the product.

25. The product according to claim 24 in a form selected from the group consisting of meatballs, sticks, croquettes, patties, tear drops, bars, Strombolis, and pizza crusts.

26. The product according to claim 25 wherein the product is a pizza crust that was made by injecting carbon dioxide while mixing until the mixture reaches about 34 to 36 degrees F.

27. The product according to claim 25 wherein the product is a pizza crust having a plurality of voids of about 100 nanometers to 1 cm in size.

28. The product according to claim 25 wherein the product is a pizza crust that when cooked and subjected to a taste test in a statistically significant population of adults, the overall liking-crust flavor scores greater than 6.0 on a 9-point Hedonic mean.

29. The product according to claim 25 wherein the product is a pizza crust that when cooked and subjected to a taste test in a statistically significant population of adults, greater than 60% of the adults respond that the crust thickness is near ideal.

30. The product according to claim 25 wherein the product is a pizza crust and has less than 10% of the daily value of total carbohydrates per serving.

31. The flourless pizza crust of claim 15 prepared by a process comprising: (a) a product forming step to make a raw dough, (b) a flattening step, (c) a product setting step, (d) a cooking step, (e) a freezing step, and (f) a reheating step.

32. The pizza crust of claim 31, wherein the product forming step comprises at least one of the following steps: (a) a blending step, (b) a carbon dioxide injection step, and (c) a shaping step.

33. The pizza crust of claim 31, wherein the product forming step comprises the use of carbon dioxide.

34. The pizza crust of claim 33, wherein carbon dioxide is injected into the dough at a temperature of about 25 to about 28 degrees F.

35. The pizza crust of claim 32, wherein the blending step comprises combining two or more ingredients.

36. The pizza crust of claim 31, wherein the flattening step comprises using a belt press.

37. The pizza crust of claim 31, wherein the setting step comprises one or more of searing, grilling, or par frying.

38. The pizza crust of claim 37, wherein the raw dough is par fried.

39. The pizza crust of claim 38, wherein the raw dough is par fried for about 5-90 seconds to set the dough.

40. The pizza crust of claim 39, wherein the raw dough is completely submerged in either oil or water at a set temperature for a determined time to achieve 360-degree coverage and heat transfer into the dough.

41. The pizza crust of claim 40, wherein the raw dough is par fried for about 15-60 seconds to set the dough.

42. The pizza crust of claim 31, wherein a cooking device is used in the cooking step and wherein the cooking step occurs at a temperature between about 200-500 degrees F.

43. The pizza crust of claim 42, wherein the cooking step occurs at a temperature between about 200-500 degrees F. and humidity in the cooking device is between 20%-60% as measured by standard humidity control systems.

44. The pizza crust of claim 43, wherein cooking time is between about 2-30 minutes.

45. The pizza crust of claim 31, wherein freezing is accomplished by a standard freezing device cooled by ammonia or carbon dioxide during the freezing step and wherein a frozen dough is formed.

46. The pizza crust of claim 45, wherein the reheating step comprises at least one of the following steps: (a) a topping step to add additional ingredients on top of the pizza crust and (b) an additional pre-reheating step.

47. The pizza crust of claim 46, wherein the additional pre-reheating step comprises thawing of the frozen dough and adding an edible substance to help prevent sticking of the dough during reheating.

48. A flourless pizza crust having the appearance and taste of a traditional flour-containing baked dough, comprising:
a. about 50% to 85% by weight chicken;
b. about 1% to 10% by weight water;
c. about 1% to 15% by weight egg white; and
d. about 0.1% to 5% by weight flavoring;
wherein the pizza crust has at least one of the following characteristics:
(i) a thickness from about 1/16 inch to about 1 inch,
(ii) a fat percentage after cooking of less than about 40% by weight,
(iii) a plurality of voids of about 100 nanometers to 1 cm in size,
(iv) a diameter of about 6 to 20 inches, and
(v) less than 10% of the daily value of total carbohydrates per serving.

49. A flourless crust, comprising:
a. about 65% to 80% by weight chicken;
b. about 1% to 3% by weight water;
c. about 5% to 15% by weight liquid egg white;
d. about 5% to 15% by weight mozzarella cheese; and
e. about 1% to 3% parmesan cheese.

50. The flourless crust of claim 49 wherein the crust is prepared by:
a. mixing the chicken, water, liquid egg white, mozzarella cheese and parmesan cheese to form a dough;
b. stuffing the dough into one or more plastic casings to a round diameter of about 5 to about 10 inches; and
c. freezing the dough.

51. The flourless crust of claim 50 wherein the dough is tempered to a temperature of about 24-28 degrees F., sliced, and then cooked.

52. The flourless crust of claim 50 wherein the diameter is about 8.5 inches.
